(19) United States
(12) Patent Application Publication
(10) Pub. No.: US 2009/0037254 A1
(43) Pub. Date: Feb. 5, 2009

(54) Sponsored Content Responsive to Rules

(76) Inventor: Marc David Colando, Seattle, WA (US)

Correspondence Address: Marc D. Colando, 14011 Alpine Way NW, Seattle, WA, 98177, US

(21) Appl. No.: 12/109,581

(22) Filed: Apr. 25, 2008

Related U.S. Application Data
(60) Provisional application No. 60/914,596, filed on Apr. 27, 2007.

(51) Int. Cl. G06Q 30/00

(52) U.S. Cl. 705/10; 705/14

(57) ABSTRACT

The disclosure is directed to a method and apparatus in which sponsors upload advertisements into a database and create rules and rule parameters regarding the use of the advertisements and specify arguments for certain of the rule parameters; publishers upload content, view available sponsors, select advertisements and the spacial-temporal locations in which to place the advertisements within the content; the uploaded content and advertisements are combined with a watermark and technology to solicit and receive viewer feedback, which may constitute arguments for certain of the rule parameters; the combined content-advertisement is made available to the audience via publication venues; the audience views the combined content-advertisement, optionally provides feedback, and rules are acted upon.

### STATEMENT OF RELATED APPLICATIONS

This application claims the benefit of provisional application 60/914,596, titled “Sponsored Content Responsive to Rules”, filed on Apr. 27, 2007.

### BACKGROUND

“Publishers,” as used in this document, refers to anyone who communicates “content” through any media. “Content,” as used in this document, is meant to broadly refer to information and/or experiences created by individuals, groups, institutions, and/or technology, which information and/or experiences are recorded or otherwise fixed in media and communicated to one or more people, the “audience.” “Content” is often conceived of under copyright law as referring to an original act of authorship; however, in this document “content” is meant to encompass information and experiences more broadly, whether original or not and including information and experiences where authorship is uncertain or irrelevant. Communication of content to an audience generally requires some modicum of expenditure on the part of the publisher and the audience, whether of time, money, energy, materials or any combination thereof. Consequently, communication of content generally, though not exclusively, occurs in a context in which the publisher and/or the audience places some value on the content and/or on the act of communication.

“Sponsors,” as used in this document, refers to anyone who pays some consideration, whether to a publisher, a media outlet, to an audience, and/or to another party as part of the communication of content. Sponsors include, though are not limited to, parties with a product and/or service and who own, license, or have a trade- and/or service mark interest in the product and/or service. A “sponsored communication” is one in which a sponsor pays some form of consideration as part of the communication of content. In a typical though by no means exclusive example of a sponsored communication is a weekly paper which is distributed with no charge to the audience. The publisher of the paper pays to have the paper printed and may pay writers and photographers to provide content for the paper. Sponsors pay the publisher in exchange for being allowed to include advertisements in the paper.

“Advertisements” are a subset of “content,” as broadly defined above. Advertisements generally, though do not exclusively, include information relating to a sponsor and/or a sponsor's products and/or services, such as where to find or otherwise how to procure the product and/or services. Occasionally, advertisements may include art or non-commercial messages. To address such instances, the definition of “advertisement” in this document is that it is content which a publisher has been paid to include with or in other content, which other content the publisher has generally paid some form of consideration (whether of time, money, energy, or materials) to produce. To the extent that it is necessary to distinguish between the two, this document will refer to “publisher's content” (the articles, for example, which a publisher pays writers to write) and “sponsored content” (the articles, plus advertisements, plus additional material, as defined more fully below).

Historically, there have been a certain number of publishers who have been outnumbered by a greater number of sponsors. There have been a large number of companies producing products and/or services, while there have been few publishers producing content for communication through newspapers, radio, and television. See, for example, FIG. 100, where this relationship is graphically illustrated. At least in part, one factor keeping a check on the number of publishers has been the cost of communication. Historically, it has required significant capital investment to purchase broadcast spectrum and facilities for radio and/or television or to print and distribute a periodical, to say nothing of the cost of developing the content; such an investment must be borne for a sufficient period to entice advertisers to use the publisher and to test the ability of the publisher to maintain a financially rewarding and symbiotic relationship between the sponsors, the publisher, the content, and the audience.

Historically, the relationship between publishers and sponsors was determined largely by terms dictated by publishers, terms often contained in rate cards and communicated to sponsors through and by advertising/media purchasing agencies. In a very real sense, information regarding the publishers was (and is) a form of content which the sponsors value and which content the advertising/media purchasing agencies invest in. The advertising/media purchasing agencies aggregated content (information) regarding the publishers, such as their rates, their audience, their lead-time and other supply and scheduling requirements, and information regarding audience response to past advertising campaigns. A sponsor seeking a publication outlet for advertisements would pay one or more advertising/media purchasing agencies (according to many different business models) to provide content (information) regarding publishers and to facilitate the relationship.

Content and its sponsored communication to an audience is inextricably bound-up with the communication media. Computer-driven media is beginning to reduce or at least to shift the costs of publication. Where it used to require tens or even hundreds of thousands of dollars to produce an audio-visual narrative with a topic such as driving a pickup truck through mud, it is now relatively inexpensive to produce at least a low-budget version of such a narrative—what shall be referred to herein as “user generated content.” It should be understood that user generated content is still “content,” as defined herein, and that the “user” who makes the user generated content is still a “publisher” as defined herein. The distinction between user generated content and traditional categories of content is that user generated content is generally lower budget and produced by a person or people who do not generally produce such content for a living. Distribution of any content to a wide audience still generally requires costly sponsorship to inform the potential audience that the content exists and where to find it; however, publishers of user generated content often have more modest goals of reaching smaller audiences comprised of friends and family, generally on the order of tens or perhaps hundreds of viewers. “Word of mouth” and personal recommendation, also referred to as “viral marketing,” may be enough to inform a hundred friends and relations that the low-budget pickup truck video is available to be viewed at a website. If the content piques the interest of viewers, then viral marketing may be enough to inform a large audience that the user generated content is available.

Social networking sites such as YouTube, Facebook, MySpace, Flickr, and many others have found that they can provide low-cost or even “free” (from a user perspective) hosting of otherwise memory- and bandwidth-intensive user generated content, often comprising photographs and videos, with the service being paid for by placement of sponsored advertisements in association with the user generated content. In many respects, such social networking sites act as advertising/media purchasing agencies: they develop a base of sponsors, attract publishers of user generated content with “free” tools and resources, and match sponsors with content.

Computer-driven media has and continues to reduce the costs of publication (and, to a lesser extent, the cost of marketing). As the financial barriers to becoming a publisher have gone down, there are more publishers, each with a smaller audience, while the number of sponsors has remained essentially the same (the number of sponsors may have increased, but not as quickly as the increase in the number of publishers). We have gone from a world with relatively few publishes being courted by many sponsors, FIG. 100, to a world of many publishers and many sponsors, FIG. 101. In both worlds, a limited set of parties mediate the relationship between publishers and sponsors, as is illustrated in FIG. 1.

Social networking sites, however, do not allow the publisher to pick the sponsor. In a typical social networking context, sponsors are matched to publishers through keywords. The content may contain text, a publisher may provide text to describe the publisher's content, there may be algorithms to programmatically categorize or to otherwise describe the content using keywords (such as by indexing text found in or associated with the content, through optical character recognition and/or through image and speech recognition), and viewers are invited to comment on the content, generating another source of keywords regarding the content. Other business models exist, but sponsors may then bid on or otherwise negotiate a price they are willing to pay in order to associate an advertisement with an instance of content which is associated with a keyword or keywords.

An example of an automated website sponsorship system which exists at this time is Google Inc.'s AdSense™ program. Automated systems index a website for keywords (including keywords which may be supplied by the website operator for this purpose), the website operator may exclude advertisements from certain sponsors or may exclude advertisements from certain categories of sponsors (such as sponsors in adult entertainment industries), sponsors bid on keywords, sponsor-bid keywords are matched with websites with corresponding keywords, advertisements from the winning sponsors are served to the websites found to have corresponding keywords, and website operators may select default advertisements to appear if the algorithmic keyword bidding and matching system is unable to find a match.

When a particular instance of content is served to an audience by social networking sites, many social networking sites determine the keywords (or equivalent) associated with the content, determine which sponsors purchased the right to serve advertisements in association with content associated with such keywords, and then pick corresponding advertisements and serve them as, for example, part of a website including the user generated content. Again, other business models exist, but, to describe a typical economic relationship which exists in the art, when the audience views the user generated content and clicks on a sponsored advertisement served with the user generated content, the sponsor pays the operator of the social networking site the amount which was negotiated or determined by the sponsor's keyword bid. Providers of content can skew which sponsors they are matched with by associating their content with certain keywords or by excluding specific sponsors or categories of sponsors, but, by-and-large, the process is one-way (sponsors select which keywords their advertisements may be associated with), is largely automated, and does not involve audience feedback.

Operators of social networking sites have financial incentives to serve advertisements which are of interest to the audience and which will be clicked on more often. The publisher of user generated or other content has a financial incentive to use the sponsor-supported social networking site to reduce the cost of publication and to benefit from viral marketing which may be enabled by the social networking site, but the publisher does not select sponsors, does not directly benefit from the sponsors which may be associated with the publisher's content, and does not have a direct financial incentive to see that advertisements are served which are of interest to the audience and which will be clicked on more often.

While the keyword match and/or the keyword auction is probably better than randomly assigning advertisements to content, the keyword match and/or auction will fail to match sponsors with content when the affinity relationship between the two is not well known and understood. For example, the publisher of the video regarding riding the truck through the mud may be about to get married and may be aware that many of the viewers of the video (people in the publisher's peer and familial group) are interested in buying wedding presents. This information is readily known to the publisher, but is difficult or at least expensive for the operator of the social networking site and/or the sponsor to know. The traditional keyword match and/or auction approach to selecting advertisements to sponsor the truck video would have a low probability of matching a department store advertisement with the truck video, and an even lower probability for an advertisement for the department store where the couple has a wish list. In addition, the video may show a truck and may be associated with the keyword “truck,” causing advertisements provided by sponsors, such as a truck manufacturer, to be shown in association with the truck video. However, the mere presence of this keyword does not reveal that this particular video may convey a meaning antithetical to the truck manufacturer's relationship with the likely audience, such as that this truck breaks down in the mud, stranding the bride-to-be in the vehicle. Showing an advertisement for a truck manufacturer under such circumstances may be counter-productive for the truck manufacturer or at least may result in a low rate of converting advertisement viewers into product buyers.

In addition, the audience at a social networking site may be provided with a “comment” or “discussion” or “blog” board or similar, which may be analyzed to develop keywords regarding an item of content, or, if something goes wrong, to chronicle the audience's reaction to a particular item of content and its association with a sponsor. However, this feedback channel must be interpreted by a human to be fully understood, which is time consuming, or, if processed by a machine, again operates on an algorithmic basis which misses semantic content which may be obvious to the publisher and the publisher's audience and/or which will not be relevant to the next truck video which might otherwise share similar keywords.

The art has not provided a content posting system which includes a structured audience feedback mechanism including rules which are executed depending on audience feedback and wherein certain of the rules interact with sponsorship of the content. The art has not provided a method or system in which a publisher who posts content to a publication venue not immediately within the control of the publisher is more actively involved in picking sponsors, in which the publisher has a financial incentive to pick sponsors, which provides a structured audience feedback mechanism, and which provides a set of rules and a system to automatically act on audience feedback and other events.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the disclosed invention is directed to a method and apparatus in which sponsors upload advertisements into a database and create rules and rule parameters regarding the use of the advertisements and specify arguments for certain of the rule parameters; publishers upload content, view available sponsors, select advertisements and the spacial-temporal locations in which to place the advertisements within the content; the uploaded content and advertisements are combined with a watermark and technology to solicit and receive viewer feedback, which may constitute arguments for certain of the rule parameters; the combined content-advertisement is made available to the audience via publication venues; the audience views the combined content-advertisement, optionally provides feedback, and rules are acted upon. Certain of the rules may be based, for example, on audience size and may result in payment flowing from the advertisers to publishers based on arguments related to viewership; other rules may be driven by audience feedback and may cause the combination of the content and advertisement to be discontinued and/or for the content to be combined with a different advertisement.

### BRIEF DESCRIPTION OF THE DRAWINGS

FIG. 1 is an illustration relevant to the background discussion.

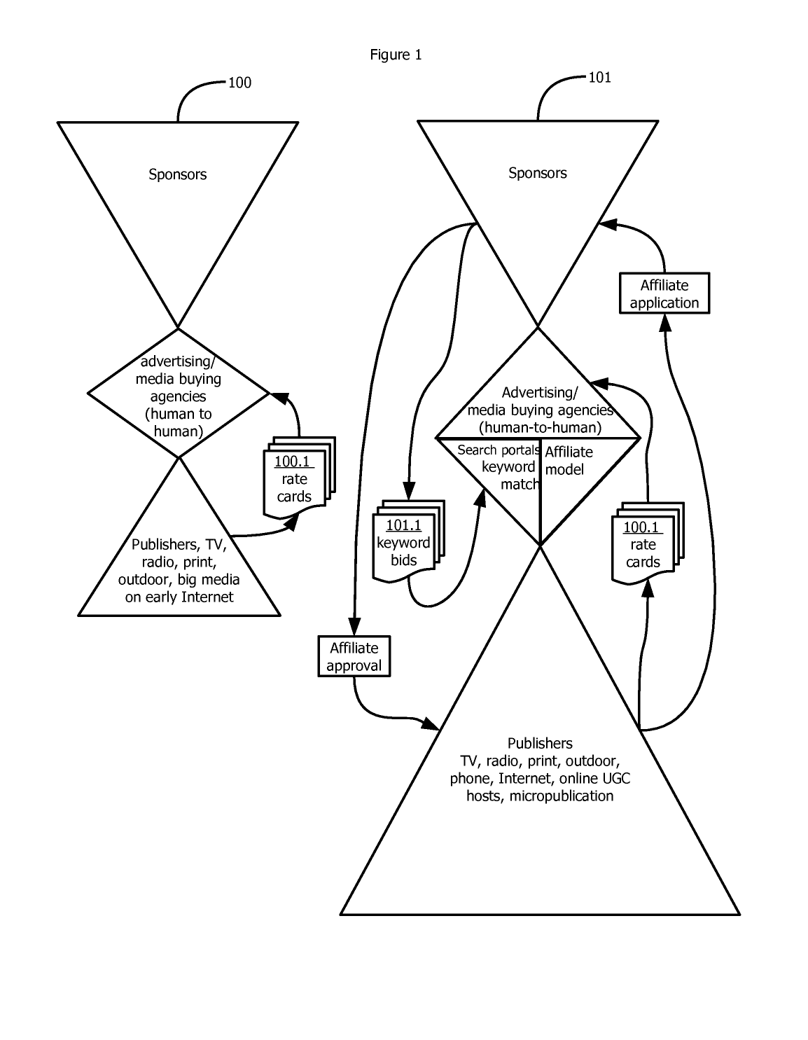

FIG. 2 is an exemplary network and device diagram in and through which systems and methods consistent with the principals of the invention may be implemented.

FIG. 3 is an exemplary network and device diagram in and through which systems and methods consistent with the principals of the invention may be implemented.

FIG. 4 is an exemplary network and device diagram in and through which systems and methods consistent with the principals of the invention may be implemented.

FIG. 5 is an exemplary network and device diagram in and through which systems and methods consistent with the principals of the invention may be implemented.

FIG. 6 depicts is an operational flow diagram generally illustrating steps consistent with certain aspects of the invention.

FIG. 7 depicts is a functional block diagram of an exemplary computing device that may be used to implement one or more embodiments of components of the invention.

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications, such as “browser,” “webserver,” or “db,” which is an abbreviation of “database.” The labels and the following discussion use these terms and related terms such as “website” as examples and not as limitations. Equivalent functions may be provided by other software applications operating on general and/or specialty purpose devices. Thus, references in this document to a browser, a webserver, or a database should be understood to describe any software application providing similar functions, operating on suitable hardware for such software application, and provided with suitable communication facilities. References to a “network” shall be understood to describe any suitable network capable of providing communication between the other components, such as but not limited to the Internet.

As described further below, this document discloses a method, system, and apparatus in which sponsors upload advertisements into a database, create and/or select rules and rule parameters regarding the use of the advertisements; publishers upload content, view available sponsors, select advertisements and the spacial-temporal locations in which to place the advertisements within the content; the uploaded content and advertisements are combined with a watermark and an audience feedback mechanism (the combination being referred to herein as “sponsored content”); the sponsored content is uploaded to publication venues and made available to audiences; audiences view the sponsored content and optionally provide feedback; the feedback and other events are programmed to be arguments with respect to rule parameters and may, for example, cause the sponsored content to be discontinued and/or for the sponsored content to be combined with a different advertisement. Further discussion of the rules and rule examples may be found below.

The components depicted in the figures represent function groups; it should be understood that such function groupings need not exist as discrete hardware devices or software applications and that the functions described as occurring within, comprising, or being provided by a grouping may be provided within or by common or separate physical and/or logical hardware and software devices. The components within and comprising any of the function groupings may be regrouped in other combinations and certain of the functions may be omitted without deviating from the spirit of the disclosed invention.

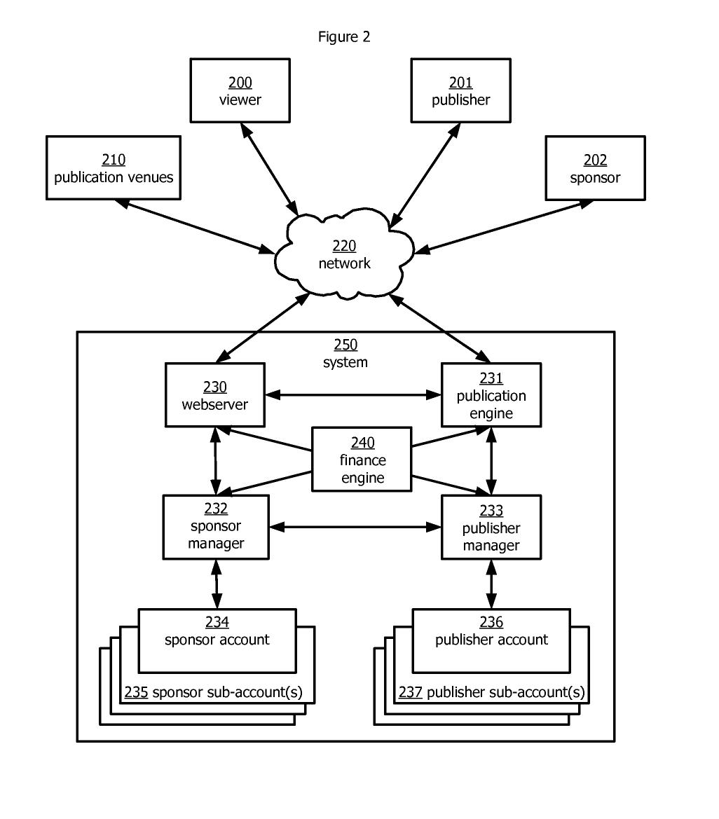

FIG. 2 provides an overview of components and systems in and through which the disclosed invention may be practiced. Depicted are one or more viewers 200, publishers 201, sponsors 202, and publication venues 210 which may communicate over a network 220, such as the Internet. Within the overall inventive system 250, there is depicted at least one webserver 230 and publication engine 231, which are connected to and may communicate over a network 220, such as the Internet. Also depicted within the system 250 are the sponsor manager 232, a publisher manager 233, and a finance engine 240, which are not depicted as being directly connected to an externally facing network 220, though such a connection may exist (not shown, discussed further below). The sponsor 234 and publisher 236 accounts are depicted as being associated with sponsor sub-accounts 235 and publisher sub-accounts 237. A sub-account or “child” account, as used in this document, is an account which may be controlled by one or more “parent” accounts above the level of the child account. Sub-accounts may be used, for example, by a sponsor or publisher to allow one or more employees or contractors to act on behalf of the sponsor or publisher, potentially with limited authorization and with oversight. Functions relating to sub-accounts are discussed further below.

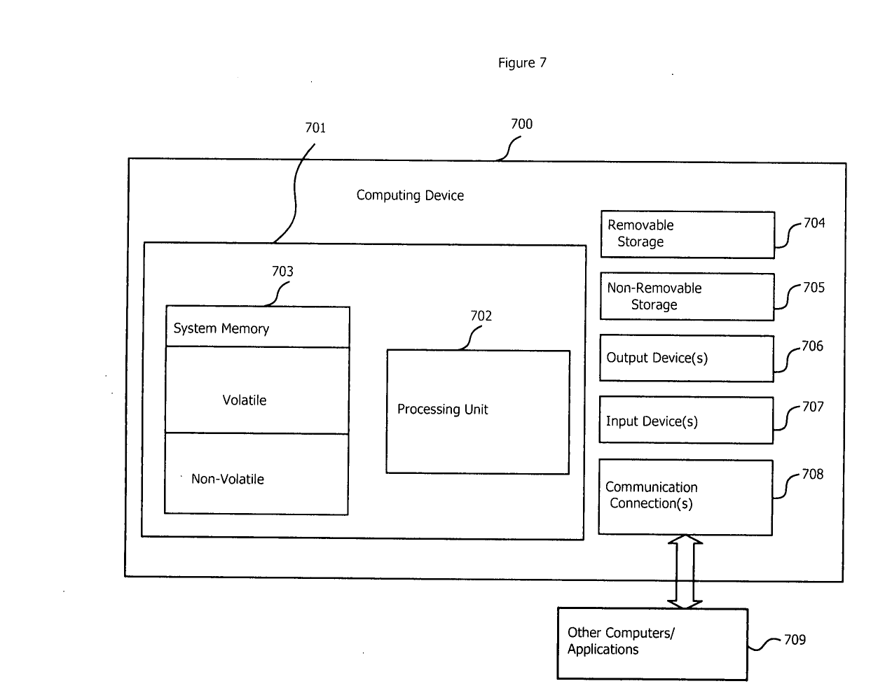

Viewers 200, publishers 201, and sponsors 202 may be operating browser application software loaded and executing on a general purpose computer, generally though not exclusively of the type shown in FIG. 7. The browser application software provides at least the functions of requesting content, rendering content for display or performance, and displaying or performing the rendered content. The content may be obtained over the network 220 from a remote memory resource, such as from one or several servers or from a distributed file sharing system such as a peer-to-peer file sharing network, such as a BitTorrent™ network, or the content may be present in a local memory resource, such as in removable storage 704, such as a DVD (digital video disk), or non-removable storage 705. The browser further provides the functions of executing application software necessary to enable the feedback mechanism, such as by displaying one or more hyperlinks which audience members may click on, as discussed further below. The browser may further provide functions relating to the authentication of user feedback and/or user content views. For example, the browser may provide information to the system 250 regarding cookies on a viewer's computer (such as cookies provided to registered and unregistered viewers), the IP address used by a viewer 200, a viewer's certificate, the viewer's system configuration or other information relating to a viewer 200 and/or service providers utilized by a viewer 200, which information may be used to score the probability that a viewer is legitimate and/or which may be used to identify a viewer over time.

As noted above, the functions described for the browser 200 may be provided by one or more suitable software applications and/or operating system software, in combination with a specialty and/or general purpose computer. While browser software operating on a general purpose computer comprises a typical example, similar functions may be provided by other software applications and/or specialty purpose computers, such as are found in and/or provided by a cable system set-top box and software executed thereon.

Publishers 201 also upload content while sponsors 202, described further below, upload advertisements into the system 250. As such, publishers 201 and sponsors 202 also may use software applications and hardware to create, edit, and store the content and advertisements. Audio, video, and text creation and editing software applications and hardware are well known in the art. For example, digital cameras and video recorders record and frequently also edit audio and video, then, often in combination with a general purpose computer and content editing software, convert into and store the resulting content in well known file formats, such as BMP, JPEG, TIFF, RAW, PNG, GIF, WMA, AAC, WAV, AIFF, MP3, MP4, and QuickTime. Publishers 201 and sponsors 202 may utilize well known communication techniques and systems (not shown) to upload content to the system 250, such, for example, an FTP server or a webserver, and/or may utilize a distributed memory and file transfer system, such as, for example, Bitorrent. Publishers 201 and sponsors 202 may also have their content and/or advertisements already available over the Internet, such as through or at a publication venue 210. In which case, uploading the content and/or uploading the advertisements may involve the system 250 accessing the content, either through the access which may be provided to the public and/or by accessing the publisher's and/or sponsor's account at the publication venue 210.

Publication venues 210 comprise any content source. Publication venues 210 are generally through not exclusively network 220 accessible. Publication venues 210 may include publishers 201 and sponsors 202, which parties may operate their own webservers (not shown) to host content and serve it in response to content requests. In an embodiment, hosted publication venues 210 comprise hosted memory and computing resources which more than one publisher may utilize. Hosted publication venues 210 often provide tools, such as website creator tools and audio and video editing tools, to allow publishers 201 to create and/or modify content. Hosted publication venues 210 may be general purpose and/or may be targeted at specific types of content, activities, and/or groups of users with a common interest. Examples of hosted publication venues 210 include Google Base, Geocities, Jotspot, Facebook, MySpace, and similar. Publication venues 210 may also be provided by peer-to-peer file sharing protocols and networks, such as Bitorrent, eDonkey, Kad Network, Ants, Gnutella, and Direct Connect. References herein to “publication venues 210” include both hosted, non-hosted, and peer-to-peer publication venues, as defined above.

Also shown in FIG. 2 as part of the overall system 250 are a webserver 230, a publication engine 231, a sponsor manager 232 and a publisher manager 233. The webserver 230 may be configured to serve webpages, at least part of which may be written in html or a similar markup language, and/or other content bearing data streams or files formatted and encoded for presentation through computer application software and which may be served to and rendered by the viewer 200. The webserver 230 may be used to provide a web-based or similar interface to the sponsor manager 232, the sponsor accounts 234, 235, the publisher manager 233, the publisher accounts 236, 237, and the publication engine 231. For example and not as a limitation, it would be understood in the art that these components may also be accessed via an application program interface (“API”) or similar, without the use of a webserver 230.

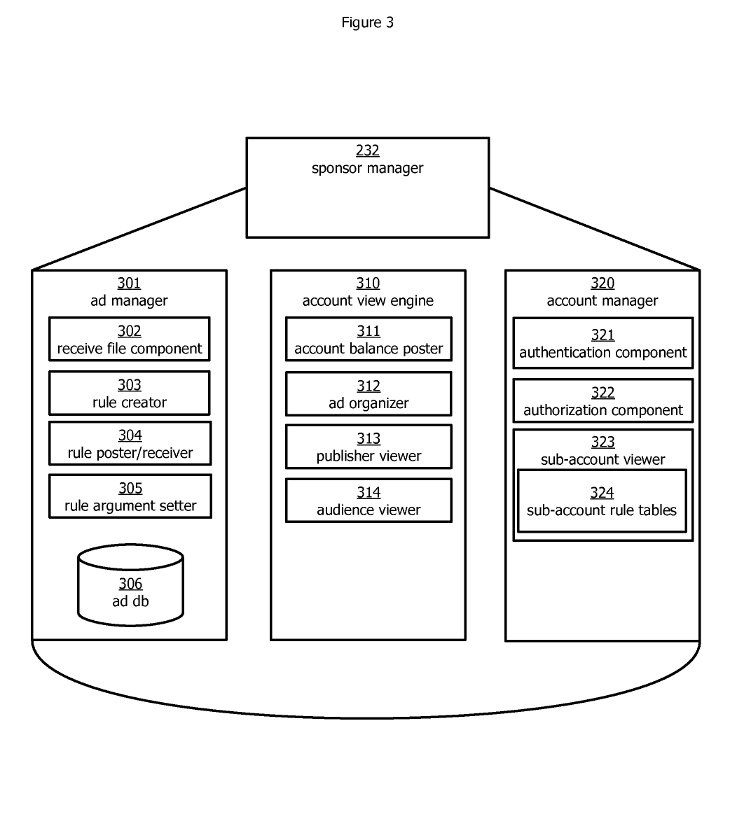

Further details regarding the sponsor manager 232 are depicted in FIG. 3. The sponsor manager comprises components to allow sponsors to login to and manage sponsor accounts, to view pertinent information regarding sponsor accounts, to upload advertisements, and to create rules, rule parameters, and to provide arguments for certain rule parameters, all relative to the uploaded advertisements and as described further below.

FIG. 3 shows the sponsor manager 232 comprising an ad manager 301, an account view engine 310, and an account manager 320. The ad manager 301 is further depicted as, for example, comprising a receive file component 302, a rule creator 303, a rule poster/receiver 304, a rule parameter-argument setter 305, and an advertisement db 306. The sponsor manager 232 may provide visualizations of data in relation to advertisements and sponsor accounts. The sponsor manager 232 may do so by collecting data and using the collected data to complete one or more templates which is or are then served as a webpage or webpages.

The receive file component 302 may receive advertisements uploaded by sponsors 202, process the received advertisements into one or more file formats used by the system 250 and/or by publication venues 210, and forward the processed advertisements to the advertisement database 306 (or, equivalently, mediates an exchange of addresses between the advertisement database 306 and the sponsor so that the sponsor 202 may transmit the advertisements to the advertisement database).

The rule creator 303 may provide, for example, classes, methods, data types, and objects which allow the system operator and/or sponsors to create rules and rule parameters governing how uploaded advertisements may be used, how compensation will be paid for the use of the advertisements, what arguments will be passed to the rule parameters and by what, and how automated systems will respond to viewer feedback and other events which may constitute a rule argument. Access to the rule creator 303 may be limited to the system 250 administrator, to the top level of a sponsor account 234, and/or to sub-levels of sponsor account 235 which have been provided with authorization to use this function. Rules, rule parameters, and rule parameter arguments may be stored in a file or database, such and not limited to the advertisement db 306. The rule poster/receiver 304 determines which rules which are available to a given sponsor account 234 or 235 and allows the sponsor 202 to associate rules with an advertisement. The rule parameter argument setter 305 receives argument parameter settings assigned to one or more advertisements by a sponsor 202 and, if not already part of the publication engine 231 or other component, forwards the settings to the publication engine 231 or other component to the extent that the publication engine 231 or other component may need such settings.

The account view engine 310 provides visualizations of data representing sponsor accounts 234 and sub-accounts 235 to sponsors 202. The account view engine 310 may do so by collecting data and using the collected data to complete one or more templates which is or are then served as a webpage or webpages. By way of example and not as a limitation, the account view engine 310 is depicted as further comprising an account balance poster 311, an ad organizer 312, a publisher viewer 313, and an audience viewer 314. The account balance poster 311 may be configured to obtain and provide visualizations of accounting information, such as payments and pre-payments made by a sponsor, credit available to the sponsor, anticipated and completed payments owed to publishers for running the sponsor's advertisements, and the like, with further information to associate payments with specific advertisements and/or groups of advertisements, specific time periods and/or ranges, specific publishers and/or groups of publishers. The account balance poster 311 may provide similar accounting activity information relating to the sponsor's sub-accounts. The account view engine 310 may obtain the accounting information from, for example, the finance engine 240.

Similarly, the advertisement organizer 312 may be configured to obtain and provide visualizations of information regarding the sponsor's advertisements. Such information and visualizations may include, for example, thumbnails and audio snippets from the advertisements, names given to advertisements and/or files, keywords associated with advertisements, categories created by the sponsor (such as folders or similar for different advertisements or advertisement campaigns), the time when an advertisement was uploaded, the file size and type, the times an advertisement was selected by publishers, which publishers selected which advertisements, which publication venues the advertisements appeared on, the rules assigned to an advertisement and the rule parameter arguments, the time when rules and rule parameter arguments were set and by whom, the results of rule execution (with rule execution ranging, for example, from amounts paid to publishers for audience impressions or similar, to rules which execute based on audience feedback, to rules which execute based on the passage of time or the occurrence of some other external event), and audience statistics.

By way of example with respect to the somewhat arbitrary nature of the organization of the function groups and the way in which the function groups may be reorganized without affecting the essential invention, it would be apparent to one skilled in the art that the advertisement organizer 312 could be moved within the ad manager 301 without affecting the disclosed invention. As another example, the rule argument setter 305 may be moved within the publication engine 231 and the rule implementor 504.

Similarly, the publisher viewer 313 and the audience viewer 314 may provide sponsors with a visualization of information relating to publishers and the audience. The publisher viewer 313 may provide visualizations of publishers categorized by publisher-made tags, by sponsor-made tags, by keywords associated with a publisher's content, and by various ranking systems, such as rank by age of publisher (relative to use of the system), the publishers' “Trust Rank” (which may be a rank comprising information from sponsors, audience feedback, the publisher's age in the system, and other information) and the rank of a publisher in terms of money made by the publisher, the rank of the publisher in terms of audience size, the rank of a publisher in terms of number of advertisements from a sponsor utilized by the publisher, links to the publisher's content, demographic information, to the extent available, regarding a publisher's audience, and the like. The publisher viewer 313 may also allow sponsors to provide information regarding publishers, such as to lodge abuse complaints, to tag publishers with keywords, and to tag publishers' content with keywords. The audience viewer 314 may provide visualizations of audience members and groups of audience members, for example, as part of displaying information relating to audience feedback, in relation to rule execution as rules may relate to viewership and to audience feedback, and the like. The audience viewer 314 may organize audience members and groups thereof by IP address, geographic location, cookie information, by computer configuration, by advertisements viewed, by viewer response, and according to other criteria. The audience viewer 314 may also provide information to and/or be incorporated into other components, such as the ad organizer 312 and/or the content organizer 412. The audience viewer 314 may also allow sponsors and publishers (discussed further below) to provide information regarding audience members, such as to lodge abuse complaints.

Similarly, the account manager 320 provides functions relating to and visualizations of data regarding sponsor accounts, such as the sponsor contact information, sponsor account login information, and sponsor sub-accounts, if any. The account manager 320 is depicted as, for example, comprising an authentication component 321, an authorization component 322, and a sub-account viewer 323 which further comprises a sub-account rule table 324. The authentication 321 and authorization 322 components may, for example, control how a party is authenticated to access an account and what functions the account holder is authorized to use. The authentication 321 and authorization 322 components may also contain the current authentication and authorization information required to allow a party to be authenticated to login to an account and to be authorized to access different of the account features (such as the ability to control sub-accounts, the ability to create rules, and the like). These components may further allow a party logged into the sponsor's account to change the authentication and authorization information. The sub-account viewer 323 may, for example, show contact information for “parent” accounts above the level of a sponsor's account, as well as “child” sub-accounts below the level of a sponsor's account. In the case of “child” sub-accounts, the account manager 320 may also provide access to the account manager 320, account view engine 310 and ad manager 301 as these apply to the sub-accounts. The sub-account viewer 323 may also comprise sub-account rule tables 324 which contain and describe rules applicable to sub-accounts, such as that a sub-account may or may not not be allowed to exceed a specified budget, may or may not be allowed to have credit, may or may not be allowed to modify rules using the rule creator 303 or to set rule parameters with respect to advertisements. Other of the components may access the sub-account rule tables 324 prior to allowing sub-accounts access to functions which may require authorization.

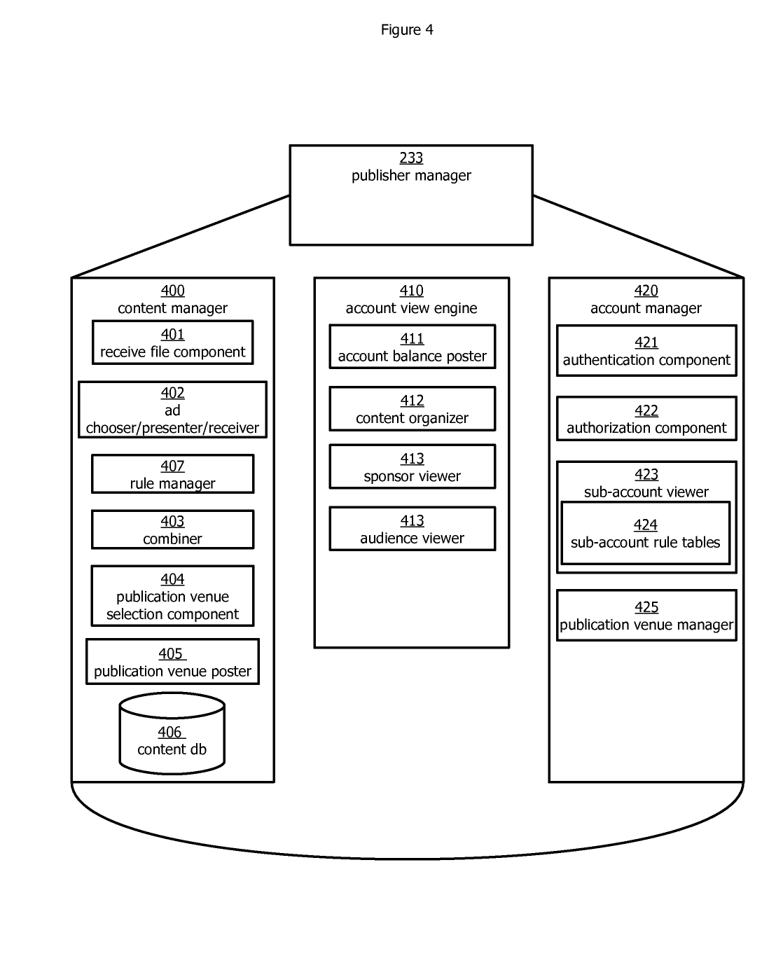

FIG. 4 depicts the publisher manager 233. Much like the sponsor manager 232, the publisher manager 233 includes components to allow publishers to login to publisher accounts, to view pertinent information regarding the account, to upload content, and to post content at publication venues, all as discussed further below. The publisher manager is depicted as comprising an account manager 420, an account view engine 410, and a content manager 400.

The content manager 400 is the set of functions which allow a publisher to upload content, to select advertisements to combine with the uploaded content, to combine the content and the selected advertisements, to select publication venues, and to post the sponsored content to the selected publication venues. The content manager 400 is depicted as comprising a receive file component 401. The receive file component 401 allows a publisher to upload content as a digitally encoded file; the receive file component 401 may re-encode the received content into one or more additional file formats and may store the received and re-encoded content in the content database 406.

The content manager 400 is further depicted as comprising a component to determine which advertisements are available to the publisher, to present these choices to the publisher, and to receive the publisher's advertisement selections 402. The advertisement chooser/presenter/receiver 402 may refer to the advertisement database 306 or other repository of rules (see discussion, above, regarding the rule creator 303, rule poster 304, and rule parameter argument receiver 305) to obtain the rules and rule parameters relevant to advertisements and/or to the authorization component 422. Information regarding the publisher attempting utilize the content manager 400 and/or the publisher's content may comprise an argument relevant to a rule parameter, which argument may be used to determine which advertisements a party is authorized to view and/or use. Depending the on the rules which apply to different of the advertisements, the advertisement chooser/presenter/receiver 402 may use information regarding the publisher and/or the publisher's content as an argument passed to a rule parameter, which may result in an advertisement not being chosen to be displayed to a publisher as an option. For example, and without limitation, if a publisher has been associated with adult entertainment in the past or if the publisher is associated with a certain kind of viewer feedback, certain sponsors may have established rules that such sponsors advertisements will not be displayed as advertisement options to such a publisher; other sponsors may be willing to sponsor other content of the publisher, but not content which is or was identified as being adult themed. In a non-exclusive alternative, information regarding the publisher and/or the publisher's content, when passed as an argument to a rule parameter may result in other outcomes, such as that a particular advertisement will pay more or less depending on, for example, the audience size. By way of further example, certain publication venues may allow only certain sponsor advertisements to appear on content hosted by such publication venue, in which case the publication venues at which a publisher is registered may comprise an argument with respect to a rule parameter in relation to one or more rules which control the advertisements selected for presentation to the publisher.

Once selected, available advertisement choices may be presented to publishers in a variety of ways. Without limitation, advertisement choices may, for example, be organized by most popular (as determined by publishers), by highest paying, by most amount paid, by keyword match relative to keywords associated with publisher's content, by allowed position in the content (beginning, end, custom location in between beginning and end, in continuous side bar or equivalent), by most recent, by most popular with viewers, by rules and parameter settings, and similar. A publisher may make more than one choice, for example, to designate that the content be combined with more than one advertisement and/or the publisher may designate one or more backup advertisements in case the rules and rule parameters operating with respect to a primary advertisement choice should result in the advertisement being discontinued (either with respect to this instance of content or generally). A publisher may, by way of further example meant to illustrate the wide range of rules which might pertain to sponsored content, select one advertisement which will be combined with the content to form the sponsored content unless a specified viewership threshold is met, in which case the original instance of sponsored content may be discontinued and a new instance of sponsored content containing a different advertisement would replace the first instance.

From the presented advertisement choices, a publisher may, for example, select an advertisement by clicking and dragging a representative thumbnail into the publisher's content; the publisher may be able to drag the advertisement to the beginning, end, into a position between the beginning and then end of the content, or into a top, bottom, or side-window adjacent to the content (to be shown while the content plays, instead of before, during, or after the content). The publisher's advertisement choice and placement selection is received by the advertisement chooser/presenter/receiver 402 and may be passed as a rule parameter argument, resulting in, for example, determination of the amount the publisher will be paid based on the spacial-temporal position of the advertisement relative to the content.

The content manager 400 is further depicted as comprising a combiner 403. The combiner 403 combines the chosen advertisement with the content in the designated position. The combiner 403 may also include a visible or invisible digital watermark, a disclaimer regarding the relationship between the content and the advertisement (which may be a result of rules, rule parameters, and arguments derived from the publisher and/or the publisher's content which are passed to the rule parameters), and an audience feedback mechanism. An example of a feedback mechanism may comprise a clickable or speakable link such as a hyperlink, radio button, drop-down list, fillable text field or similar and which, when rendered by the viewer's browser 200, allows a viewer 200 to click on, select, or say a link, select a radio button or drop-down list selection, type text into a field, record voice or video, or similar and which, when acted upon by the viewer 200, sends the viewer feedback information to a component, person, and/or location, such as the viewer feedback receiver 513 (discussed further below). The feedback mechanism may include descriptive or suggestive information to guide the viewer in understanding the feedback choices, such as a hypertext link which says, “I love it,” “Offends me,” “Works,” “Doesn't work,” “Insert comment here,” “Record message now,” and the like. The combiner 403 combines these components and formats and encodes the combination for distribution to publication venues. References herein to “sponsored content” shall be understood to refer to the combinations of content, advertisements, and the feedback mechanism described above.

The content manager 400 is further depicted as comprising a publication venue selection component 404 and a publication venue poster 405. The publication venue selection component 404 may, for example, provider the publisher with choices regarding where the publisher wants to have the sponsored content posted. These choices may be provided by the publisher, with the choices obtained from the publication venue manager 425 (discussed further below) and/or the choices may also include choices provided by the system operator or by a third parties, including by participating publication venues. Similar to above, the publication venue choices may be organized in a variety of ways, such as by audience, by historical sponsorship earnings, by name, or according to other criteria.

The publication venue selection component 404 and/or the publication venue poster 405 may further be configured to refer to the publication venue manager 425 (discussed further below) to obtain additional categories of information which may be required by the publication venue or which may be optionally provided by the publisher to the publication venue as part of posting content to the publication venue. For example, a publication venue may require the login information (for the publication venue) of the party posting the content, may allow the content to be associated with descriptive information, may allow the sponsored content to be posted to a particular webpage or part of a website associated with a user account, and similar. The publication venue selection component 404 and/or the publication venue poster 405 may determine these additional and/or optional categories of information, may pre-populate such categories with previously provided information (for example, with login and other relatively static information), may query for and/or confirm the information to be provided to the publication venues. The publication venue poster 405 may then post the sponsored content and additional information to the designated publication venues, for example through use of the publication engine 231.

The publisher manager 233 is depicted as further comprising an account view engine 410. Similar to the sponsors' account view engine 310, the publishers' account view engine 410 provides visualizations of data representing publisher accounts 236 and sub-accounts 237. The account view engine 410 may do so by collecting data and using the collected data to complete one or more templates which is or are then served as a webpage or webpages. By way of example and not as a limitation, the account view engine 410 is depicted as further comprising an account balance poster 411, a content organizer 412, and a sponsor viewer 413. The account balance poster 411 may be configured to obtain and provide visualizations of accounting information, such as payments made by sponsors, payouts made to publishers, and the like, with further information to optionally organize payment information according to advertisement, content, specific time periods and/or ranges, specific sponsors and/or groups of sponsors, and to provide similar accounting activity information relating to the publisher's sub-accounts, and the like. The account view engine 410 may obtain the accounting information from, for example, the finance engine 240.

Similarly, the content organizer 412 may be configured to obtain and provide visualizations of information regarding the publisher's content. Such information and visualizations may include, for example, thumbnails and audio snippets from the content, names given to content, content categories created by the publisher (such as folders or similar for different content), the time when content was uploaded, the file size and type, the advertisements combined with the content, viewer response to the sponsored content, which publication venues the content appeared on, the rules assigned to content and/or advertisements and the rule parameters, the time when rules and rule parameters were set and by who, the results of rule execution (with rule execution ranging, for example, from amounts paid for audience impressions or similar, to rules which execute based on audience response, to rules which execute based on the passage of time or the occurrence of some other external event), and audience statistics, for example, obtained from the publication engine 231 (discussed further below).

By way of example with respect to the somewhat arbitrary nature of the organization of the function groups and the way in which the function groups may be reorganized without affecting the essential invention, it would be apparent to one skilled in the art that the content organizer 412 could be moved within the content manager 400 without affecting the disclosed invention.

The account view engine 410 is further depicted as comprising a sponsor viewer 413. Similar to the publisher viewer 313, the sponsor viewer 413 may provide a visualization to the publisher regarding information relating to sponsors. The sponsor viewer 413 may provide visualizations of sponsors categorized by sponsor-made tags, by publisher-made tags, by keywords associated with a sponsor's advertisements, and by various ranking systems, such as rank by age of sponsor (relative to use of the system), the rank of a sponsor in terms of money paid, the rank of the sponsor in terms of viewer feedback, links to the sponsors' advertisements, demographic information, to the extent available, regarding a sponsor's consumers, and the like. The sponsor viewer 413 may also allow publishers to provide information regarding sponsors, such as to lodge abuse or non-payment complaints, to tag sponsors with keywords, and to tag sponsors' advertisements with keywords.

The publisher manager 233 is further depicted as comprising a publisher account manager 420. The publisher account manager 420 provides functions relating to and visualizations of data regarding publisher accounts, such as publisher contact information, publisher account login information, and publisher sub-accounts, if any. The account manager 420 is depicted as, for example, comprising an authentication component 421, an authorization component 422, and a sub-account viewer 423 which further comprises sub-account rule tables 424. The authentication 421 and authorization 422 components may, for example, control how a party is authenticated to access an account and what functions the account holder is authorized to use. The authentication 421 and authorization 422 components may also contain the current authentication and authorization information required to allow a party to be authenticated to login to an account and to be authorized to access different of the account features (such as the ability to control sub-accounts, the ability to create rules, and the like). These components may further allow a party logged into the sponsor's account to change the authentication and authorization information. The sub-account viewer 423 may, for example, show contact information for “parent” accounts above the level of a publisher's account, as well as “child” sub-accounts below the level of a publisher's account. In the case of “child” sub-accounts, the account manager 420 may also provide access to the account manager 420, account view engine 410 and content manager 400 as these apply to the sub-accounts. The sub-account viewer 423 may also comprise sub-account rule tables 424 which contain and describe rules applicable to sub-accounts, such as that a sub-account may or may not not be allowed to request payouts, may or may not be allowed to select certain advertisements and/or advertisements associated with certain keywords, and the like. Other of the components may access the sub-account rule tables 424 prior to allowing sub-accounts access to functions which may require authorization.

The account manager 420 is further depicted as comprising a publication venue manager 425. The publication venue manager 425 provides functions relating to and visualizations of data relating to available publication venues 210. As noted above, a publisher 201 may provide information regarding which publication venues 210 the publisher 201 uses. Such information may comprise, for example, login identifiers and passwords associated with accounts the publisher may have with publication venues. Such information may further comprise, for example, default settings the publisher may have or prefer with respect to various functions and features offered by particular publication venues, such as the publisher's base URL, base page style or other default formatting selections. The publication venue manager 425 may refer to the publication venue catalog 503 (described further below) to determine required information and options relative to the publication venue and to prompt the publisher with respect to such required information and options.

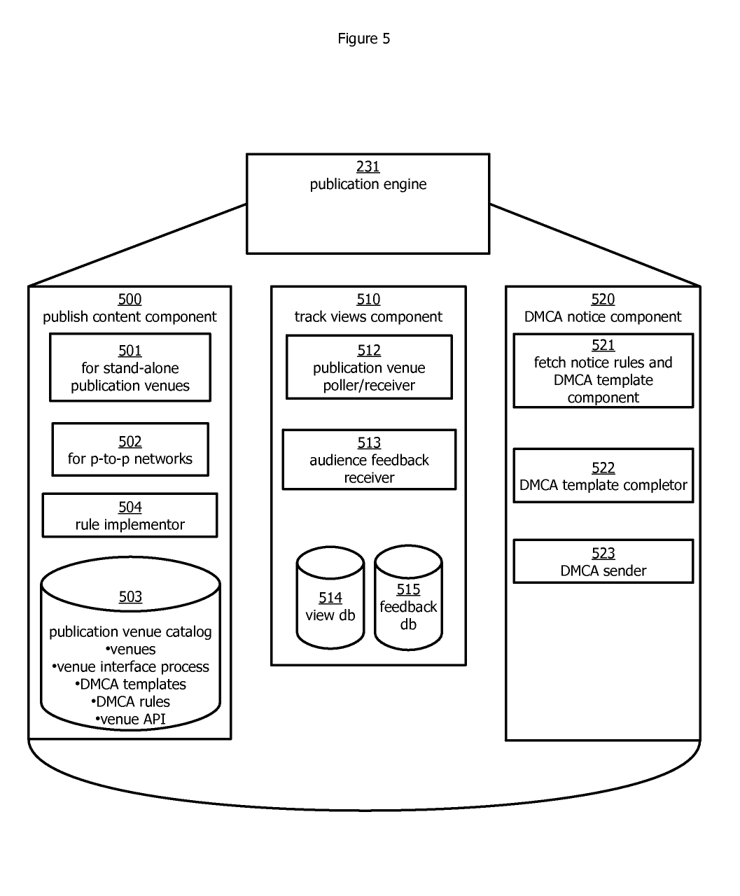

Also depicted in FIG. 2 is a publication engine 231. As described further herein, the publication engine 231 posts sponsored content to publication venues, tracks views and other metrics with respect to the sponsored content, and sends and follows up on copyright infringement notices, also referred to herein as Digital Millenium Copyright Act or “DMCA” notices. FIG. 5 provides further disclosure regarding components comprising the publication engine 231. FIG. 5 depicts the publication engine 231 as being comprised of a publish content component 500, a track views component 510, and a DMCA notice component 520.

The publish content component 500 is depicted as further comprising components to publish to stand-alone publication venues 501 and to peer-to-peer networks 502. The differing technical requirements of stand-alone publication venues and peer-to-peer networks suggest that two different components would be used to post the sponsored content to these different environments. However, and as noted above, the function groups represented in the figures are somewhat arbitrary and may be reorganized into different function groups or may be combined into fewer groups.

The component to publish to stand-alone publication venues 501 may, for example, refer to the publication venue catalog 503 to obtain the process for publishing to a particular hosted publication venue 210, such as that the publication engine must login to the publisher's account with the hosted publication venue 210 after obtaining login information from the publication venue manager 425. After obtaining the required process and supporting information, the component to publish to stand-alone publication venues 501 may login to the hosted publication venue 210 and upload the sponsored content.

The component to publish to peer-to-peer networks 502 may similarly refer to the publication venue catalog 503 to obtain the process for publishing to a publication venue 210 comprising a peer-to-peer network. Similarly, the specified process may require referring to the publication venue manager 425 with respect to a particular publisher's relationship with a publication venue. The publication venue manager 425 may, for example, contain settings with respect to whether the peer representing the publisher in the peer-to-peer network is or are one or more computers provided or specified by the publisher, in which case the sponsored content may be uploaded to such computer(s) with instructions provided to a specified file-sharing client application executed by such computer(s), or if the peer is to be provided by the system operator (in which case the upload of sponsored content and instructions is directed to such computer(s)), and/or if a particular certificate, login, or other identifier is to be used to identify the publisher in the peer-to-peer network.

The publish content component 500 is depicted as further comprising a rule implementation component 504. The rule implementor 504 checks and/or is a repository for rules created by publishers and sponsors as such rules are set with respect to sponsored content. The rule implementor 504 may refer to and/or receives information from other components, such as the track views component 510 and/or from other components (not shown) which monitor other events, such as the passage of time. For example and without limitation, the rule implementor 504 may note and/or may receive information regarding the occurrence of viewership of sponsored content. The rule implementor 504 may post information to the finance engine 240 to provide that a sponsor's account is debited and a publisher's account is credited for a view of sponsored content. By way of further example and without limitation, the rule implementor 504 may note the occurrence of viewer feedback which constitutes a rule parameter argument and which argument is then determined to meet a threshold, such as a threshold for withdrawing an instance of sponsored content and/or for changing the advertisement associated with an instance of content, such as to change to a publisher's second (or other) advertisement selection.

The publish content component 500 is depicted as further comprising a publication venue catalog 503. The publication venue catalog 503 may comprise a database of information regarding publication venues 210. Such information may comprise, for example, information regarding the process used by one or more publication venues 210 to publish and to remove a publisher's content, the information and process used to login to a publisher's account with the publication venue 210, mandatory and optional settings which may be specified with respect to use of the publication venue's services, such as graphical and organizational settings which a publisher may control. The publication venue catalog 503 may further comprise records which document or refer to API's or similar which may be used to control different of the publication venues, as well as a mapping of such API's onto one or more additional API's, such as a common API and/or a master API. The publication venue catalog 503 may further comprise records describing the DMCA rules, DMCA templates, and equivalent which copyright holders may use to lodge DMCA complaints with a publication venue 210.

The publication engine 231 is depicted as further comprising a track views component 510. The track views component 510 organizes functions relating to viewership of at least sponsored content (if not also unsponsored content) and viewer feedback. The track views component 510 may further comprise and/or may overlap with functions provided by the rule argument receiver 305. The track views component 510 is depicted as further comprising a publication venue poller/receiver 512, an audience feedback receiver 513, a database of view statistics 514, and a feedback database 515. It is understood in this document that the content may comprise audio, text, and/or other media which may be characterized as having a “listener” or a “reader” as opposed to a “viewer.” Nonetheless, references herein to “viewer” and/or “viewership” and the like shall be understood to refer more broadly to any party experiencing a sense impression as a result of perceiving content.

To the extent that the publication venues 210 collect and record viewership statistics regarding content provided to viewers 200, the publication venue poller/receiver 512 polls, as necessary, the publication venues and/or receives such information, storing the received information in the view statistics database 514. In the context of peer-to-peer networks, viewership statistics may be obtained from peer-to-peer clients which report viewing habits, third-party viewership measurement, such as is provided by Nielsen/NetRatings, and similar. To the extent that viewers interact with the audience feedback mechanism described above regarding the combiner 403, the audience feedback receiver 513 receives the resulting information and stores it in the feedback database 515.

The publication engine 231 is depicted as further comprising a DMCA notice component 520. The DMCA notice component 520 organizes functions relating to the lodging of DMCA notices with publication venues 210. The DMCA notice component 520 is depicted as further comprising a component to fetch DMCA notice rules as well as the DMCA template 521 from the publication venue catalog 503. The DMCA notice component 520 is depicted as further comprising a component to complete the fetched DMCA template 522. This component 522 may obtain information to complete the fetched DMCA template from a sponsor, a publisher, or from other components described herein, such as the account manager for a sponsor 320 or a publisher 420. The DMCA notice component 520 is depicted as further comprising a component to send the completed DMCA notices 523. The DMCA sender 523 may send the completed DMCA notices according to instructions obtained from the publication venue catalog 503. The DMCA sender 523 may further monitor for a response by the publication venue 210, such as a response described in the publication venue catalog 503 or the removal of the sponsored content from the publication venue 210.

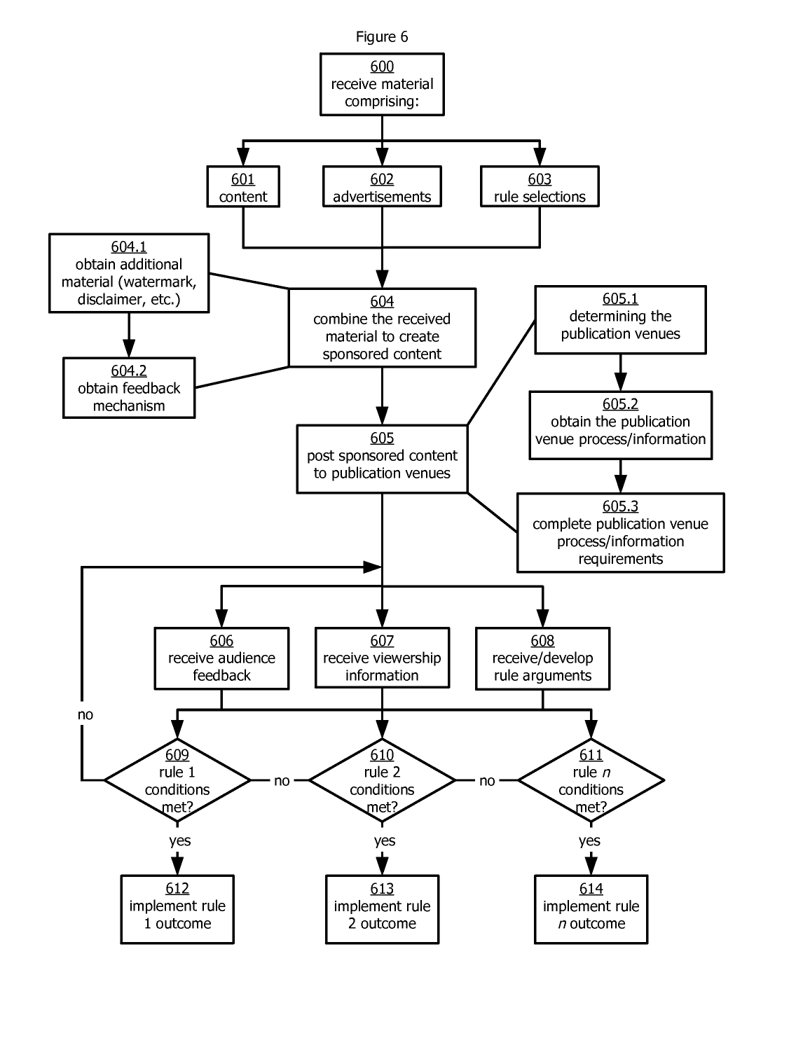

FIG. 6 depicts is an operational flow diagram generally illustrating steps consistent with certain aspects of the invention. Step 600 depicts receiving material comprising at least one publisher's content 601, at least one sponsor's advertisements 602, and rule selections by at least one of a publisher and/or a sponsor 603. As noted above, the received material may be received by upload from the party providing it or it may be received from an existing source of the material, such as a from a publication venue 210 (including via access to a party's account at a publication venue). In terms of the function groups described above with respect to the diagrammatic representation of the system discussed above, the content may be received by the content manager 400 and the receive file component 401; the advertisements may be received by the advertisement manager 301 and the receive file component 302; and the rule selections may be received by the rule poster/receiver 304 and the rule argument receiver 305, in the case of rules selected by sponsors, and by the rule manager 407, in the case of rules selected by publishers.

Following receipt of at least one of each of content 601, advertisements 602, and rule selections 603, the received material and/or rules are combined at step 604. The received material and/or rules may be combined at this step with a visible or invisible digital watermark, a disclaimer regarding the relationship between the content and the advertisement, shown as being obtained at step 604.1 and an audience feedback mechanism (as discussed further above), shown as being obtained at step 604.2. In terms of the function groups described above with respect to the diagrammatic representation of the system discussed above, the combining may be performed by the combiner 403. The combination forms sponsored content.

The sponsored content is then posted to publication venues 605. As noted above in relation to the publisher manager 233, the publisher may use the publication venue selection component 404 and the publication venue poster 405 to select which publication venue the sponsored content is posted to, shown at step 605.1, and to direct the system 250, including the publisher manager 233, to post the content. As noted above, the publication venue manager 425 may be accessed to lookup additional categories of information which may be required to be submitted to the publication venues or which may be optionally submitted to the publication venues as well as to obtain the process used to post content to the publication venue. This is shown at step 605.2. The additional information may be obtained from other components and/or the publisher, as discussed above in relation to the publication venue selection component 404 and the publication poster 405. This is shown at step 605.3

As noted above in relation to the publication engine 231 and the publish content component 500, posting the sponsored content to the publication venues 605 may involve different steps depending on whether the sponsored content is to be posted to a stand-alone hosted publication venue or if the sponsored content is posted to a peer-to-peer network. For example, a hosted publication venue 210 may require that a party, such as the system 250, login to an account with the hosted publication venue 210 and to upload the sponsored content to the hosted publication venue 210 through such account. By way of further example, a peer-to-peer file sharing publication venue 210 may also require login to an account and/or may require upload of the sponsored content and instructions to a computer (or computers) which executes a peer-to-peer file sharing application, which application may announce or otherwise make available information regarding the presence of the sponsored content and which may distribute the sponsored content to peers or other entities upon request or according to “push” rules (which distribution may utilize the peer-to-peer file sharing system).

After the sponsored content is posted to publication venues, information is obtained, received, and/or developed, which information comprises arguments passed to and utilized by the rules associated with the sponsored content. Examples are shown in steps 606, 607, and 608.

For example, certain of the information may be received from the audience feedback mechanism 606, in which case the information will be a product of the rule(s) incorporated into the particular instance of the feedback mechanism which gave rise to the information. For example, if the feedback mechanism includes one or more clickable links with options such as “Love it,” “Hate it,” “Offends me,” and similar, the feedback may comprise a code, URL, or similar which indicates that a viewer selected one or more of the links. The feedback may include additional information, such as the IP address of the user, cookies or similar identifiers present on the viewer's computer 200, configuration settings relevant to the viewer's computer 200, and similar. Instances of the received information may be ranked according to authorization criteria (not shown) selected to reduce the incidence of spurious or even fraudulent feedback information. Instances of received information with a poor ranking may be discarded without being handled as a rule parameter argument or such poorly ranking information may be processed, but perhaps with the results flagged to demonstrate a low confidence in the reliability of the information relative to the rule. For example, a first sponsor may view a second sponsor's advertisement associated with a popular instance of sponsored content. The first sponsor may select an “Offends me” feedback option in an attempt to have the sponsored content discontinued and/or in an attempt to influence the content to be associated with a different advertisement (such as the first sponsor's advertisement). The first sponsor's viewer 200 may not be registered with the system 250 and/or may have registered recently with the system 250, which may result in a lower ranking for this particular instance of feedback. Alternatively, the first sponsor's IP address may be known and may constitute an argument for a rule parameter, which rule causes the first sponsor's feedback to be discarded or flagged.

Certain of the information which may constitute a rule argument may be viewership information received from publication venues and/or from viewers 200, shown being received at step 607. Such information may be received and/or obtained by the track views component 510 and sub-components discussed above. Viewership information received from publication venues may comprise information regarding when and how often sponsored content was served by the publication venue and may further include additional information, such as the additional information discussed above which may be obtained in the context of the audience feedback, such as the IP addresses which requested the sponsored content, the time of day the sponsored content was requested and/or served, cookies and configuration settings relative to the viewer 200. With respect to certain publication venues, it may be necessary to obtain the viewership information, such as by logging into a publisher's account (or equivalent) with a publication venue and polling the publication venue to obtain the viewership information. Certain other publication venues may publicize viewership information. Viewership information from viewers 200 may include information such as data representing that playback of a file was initiated, whether playback was completed or interrupted, whether playback occurred more than once, time of playback and similar additional information such as the IP address of the viewer 200, cookies and configuration settings relative to the viewer 200, and similar.

Information regarding viewership, audience feedback, and other arguments for rule parameters may be stored in the view database 514 and the feedback database 515. Such information may then be passed to a component such as the rule implementation component 504, which may process rules, rule methods, and rule parameters to determine which rules an argument is relevant to, to pass the arguments to the rule, to process the rule, and to implement the outcome of the processed rule, steps 612, 613, and 614.

FIG. 7 is a functional block diagram of an exemplary computing device 700 that may be used to implement one or more embodiments of the invention components. The computing device 700, in one basic configuration, includes at least a processor 702 and memory 703. Depending on the exact configuration and type of computing device, memory 703 may be volatile (such as RAM), non-volatile (such as ROM, flash memory, etc.) or some combination of the two. Additionally, device 700 may also have other features and functionality. For example, device 700 may also include additional storage (removable and/or non-removable) including, but not limited to, magnetic or optical disks or tape. Such additional storage is illustrated in FIG. 7 by removable storage 704 and non-removable storage 205. Computer storage media includes volatile and nonvolatile, removable and non-removable media implemented in any method or technology for storage of information such as computer readable instructions, data structures, program modules or other data. Memory 703, removable storage 704 and non-removable storage 705 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and software applications which can be accessed by device 700. Any such computer storage media may be part of device 700.

Computing device 700 includes one or more communication connections 708 that allow computing device 700 to communicate with one or more computers and/or applications 709. Device 700 may also have input device(s) 707 such as a keyboard, mouse, digitizer or other touch-input device, voice input device, etc. Output device(s) 706 such as a monitor, speakers, printer, PDA, mobile phone, and other types of digital display devices may also be included. These devices are well known in the art and need not be discussed at length here.

What is claimed is:

1: A system to create and publish sponsored content comprised of the following components:
a component configured to receive advertisements uploaded by sponsors;
a component configured to receive rule selections by sponsors in relation to use of uploaded advertisements in conjunction with publisher content;
a component configured to receive content uploaded by publishers;
a component configured to receive selections by publishers of uploaded advertisements;
a component configured to combine at least uploaded content and at least selected advertisements with an audience response mechanism to create sponsored content;
a component configured to publish sponsored content to publication venues;
a component configured to receive audience responses initiated through the audience response mechanism; and
a component configured to process rules based on arguments with respect to rule parameters.

2: The system according to claim 1 where audience response comprises an argument with respect to at least one rule parameter for at least one rule.

3: The system according to claim 2 where the at least one rule, when processed, results in removal of at least one instance of sponsored content from a publication venue.

4: The system according to claim 1 where viewership information comprises an argument with respect to at least one rule parameter for at least one rule.

5: The system according to claim 4 where the at least one rule, when processed, results in consideration being paid by a sponsor to at least a publisher if there was at least one viewer.

6: The system according to claim 1 where the viewer response mechanism further comprises at least one hyperlink.

7: The system according to claim 1 where information associated with at least one publisher and/or the at least one publisher's content comprises at least one argument with respect to at least one rule parameter for at least one rule and where the at least one rule, when processed, results in selection of one or more uploaded advertisements to present to at least one publisher for further selection by such at least one publisher.

8: The system according to claim 1 further comprising a component configured to allow sponsors to create rules comprising parameters and methods.

9: A method in a computer system for creating and posting sponsored content, the method comprising the following steps:
receiving material comprising:
content from at least one publisher,
at least one advertisement from at least one sponsor,
sponsor rule selections associated with at least one advertisement; and
combining at least the received material with an audience feedback mechanism to form sponsored content;
posting sponsored content to at least one publication venue;
receiving information which constitutes at least one argument with respect to at least one rule parameter;
processing at least one selected rule.

10: The method according to claim 9 further comprising receiving a publisher's selection of at least one advertisement and wherein combining at least the received material with an audience feedback mechanism to form sponsored content further comprises combining the received publisher's selection of at least one advertisement with content from such publisher.

11: The method according to claim 9 where audience feedback from the audience feedback mechanism is an argument with respect to a parameter in at least one selected rule and where processing the at least one selected rule further comprises removing at least one instance of sponsored content from at least one publication venue.

12: The method according to claim 9 where viewership information is an argument with respect to a parameter in at least one selected rule and where processing the at least one selected rule further comprises crediting a publisher's account and debiting a sponsor's account.

13: The method according to claim 12 where the amount credited and the amount debited is determined at least in part based on the spacial-temporal location of the advertisement in the sponsored content.

14: The method according to claim 9 further comprising presenting sponsor advertisements to at least one publisher, from which presented advertisements the publisher may select at least one advertisement as an advertisement to be included in the sponsored content.

15: The method according to claim 9 where information associated with a publisher is an argument with respect to a parameter in at least one selected rule and where processing the at least one selected rule further comprises presenting sponsor advertisements to at least one publisher, from which presented advertisements the publisher may select at least one advertisement as an advertisement to be included in the sponsored content.

16: The method according to claim 15 where information associated with a publisher is selected from at least one of information provided by a publisher regarding the publisher and/or the publisher's past and/or present content, information provided by at least one sponsor regarding the publisher and/or the publisher's past and/or present content, information regarding a publisher's expressed preferences with respect to sponsors, information received from the feedback mechanism, information developed through programmatic analysis of the publisher's content and/or files containing the publisher's content.

17: The method according to claim 9 further comprising scoring at least one instance of audience feedback obtained from the audience feedback mechanism based on criteria including at least one of an IP address, a cookie, the number of times the audience member has provided feedback, the period of time over which the audience member has provided feedback, and/or whether the audience member has provided registration information.

18: The method according to claim 17 further comprising rejecting at least one instance of audience feedback based on the score associated with such at least one instance of audience feedback.

19: Computer readable media containing instructions for controlling for a system to create and post sponsored content by a method comprising the method of claim 9.

20: Computer readable media containing instructions for controlling an audience feedback mechanism, comprising instructions embedded within sponsored content posted to a publication venue which instructions cause the display at least one hyperlink, which instructions return data in response to audience interaction with the at least one hyperlink, where such returned data comprises at least one argument with respect to a rule parameter and where the rule which utilizes the rule parameter, when processed in view of the arguments, results in removal of the sponsored content from the publication venue.
